(19) United States
(12) Patent Application Publication
(10) Pub. No.: US 2016/0180646 A1
(43) Pub. Date: Jun. 23, 2016

(54) CASINO ENTERTAINMENT SYSTEM WITH MULTIPLE SIMULTANEOUS PROGRESSIVE WAGERS

(71) Applicant: Chi Fat Au-Yeung, Birmingham (GB)

(72) Inventor: Chi Fat Au-Yeung, Birmingham (GB)

(21) Appl. No.: 14/945,427

(22) Filed: Nov. 19, 2015

(30) Foreign Application Priority Data
Dec. 14, 2014 (GB) 1422212.9

(51) Int. Cl. G07F 17/32

(52) U.S. Cl. CPC G07F 17/3258; G07F 17/3293

(57) ABSTRACT

A method, apparatus and computer readable storage to implement a wagering game which provides multiple simultaneous progressive wagers for the players. A player makes a main wager on the outcome of the overall game and an optional progressive wager. A single progressive wager covers a plurality of progressive wager pools, each pool with its own criteria for winning the entire pool (or a portion of it). Each time the progressive jackpot is paid it is then reseeded (replenished) according to predetermined rules.

### CROSS REFERENCE TO RELATED APPLICATIONS

This application claims foreign priority to patent application number 1422212,9, filed in the Intellectual Property Office of the United Kingdom on Dec. 14, 2014, which is incorporated by reference herein in its entirety.

### BACKGROUND OF THE INVENTION

1. Field of the Invention

The present general inventive concept is directed to a method, apparatus, and computer readable storage medium directed to a casino wagering game.

2. Description of the Related Art

Casino games are a huge industry in this country. What is needed is a new casino game that will be profitable for the house and exciting and enjoyable for players.

### SUMMARY OF THE INVENTION

It is an aspect of the present invention to provide an exciting casino game.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a wagering game, according to an embodiment;

FIG. 2A is a drawing illustrating a gaming table, according to an embodiment;

FIG. 2B is a block diagram illustrating an electronic player tracking system associated with each gaming table, according to an embodiment;

FIG. 3A is a block diagram illustrating exemplary hardware that can be used to implement an electronic version of the methods described herein; and

FIG. 3B is a block diagram illustrating an exemplary network configuration to implement a player playing an online version of the methods described herein;

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a casino game which implements multiple simultaneous progressive jackpots. The player would make one progressive wager which could be applied to multiple separate progressive jackpot pools (each with its own respective criteria for winning)

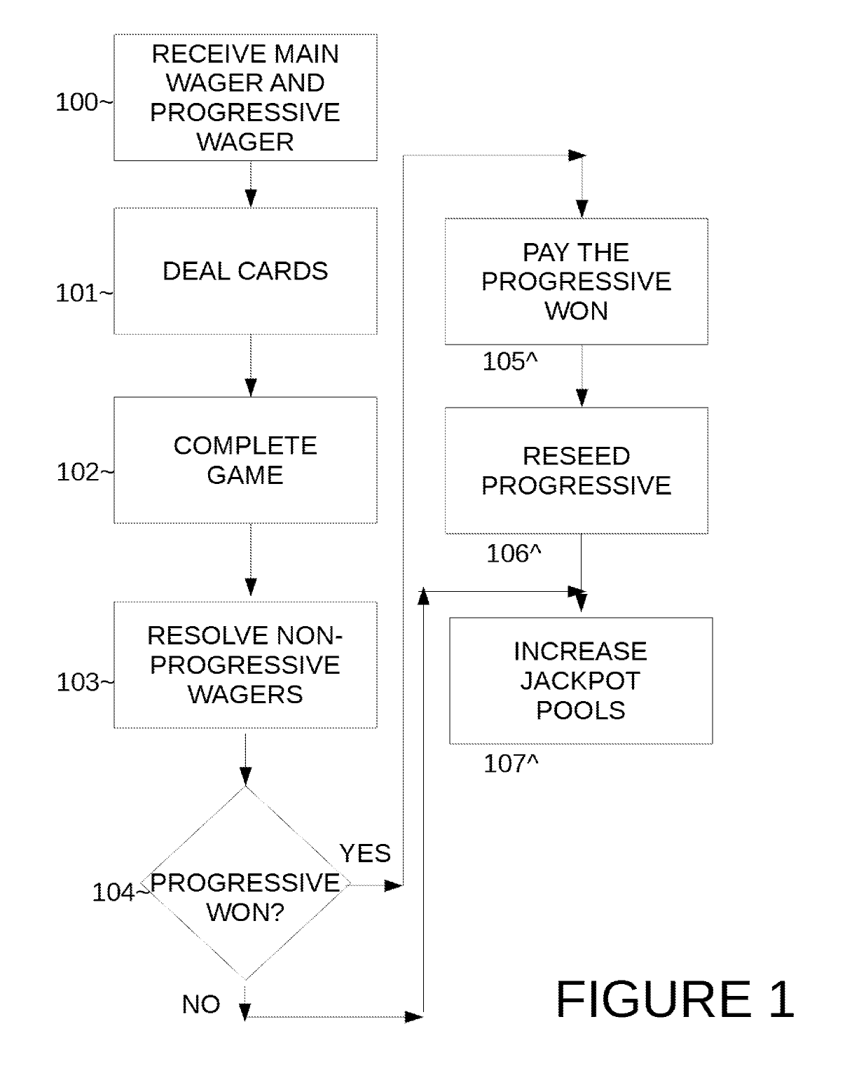

FIG. 1 is a flowchart illustrating an exemplary method of implementing a wagering game, according to an embodiment.

The method can begin with operation 100, which receives a main wager from the player which is resolved on the outcome of the game and a progressive wager. The progressive wager is typically an optional single wager (although it can be required) which applies to at least two (and can be three or more) progressive paytables. The wager can be placed as known in the art, such as placing chips (redeemable for cash) and putting the chips in betting circles (one betting circle for the progressive wager and one betting circle for the main wager).

From operation 100, the method proceeds to operation 101 which deals the cards. The number of cards dealt can vary and both a player's hand and a dealer's hand can be dealt. The cards can also be dealt face up or face down, or some cards can be dealt face up and some cards can be dealt face down.

From operation 101, the method proceeds to operation 102 which completes the game according to predetermined rules. This typically entails dealing additional cards to the player's hand and/or the dealer's hand.

From operation 102, the method proceeds to operation 103, which resolves the non-progressive wagers (e.g., the main wager placed in operation 100). The main wager is resolved based on whether the player won or lost the game. It is also possible for the player to tie, meaning the main wager pushes. If the player wins, then the player's main wager is paid and if the player loses then the player's main wager is collected by the house.

From operation 103, the method proceeds to operation 104, which determines whether the player won any of the plurality of progressive jackpots offered in the game. If the criteria is not met to qualify for any of the progressive jackpots, then the game ends.

If in operation 104, one of the progressive jackpots is won, then the method proceeds to operation 105, which pays the player a payout from the progressive pool that the player has won.

From operation 105, the method proceeds to operation 106, which reseeds the progressive jackpot that the player was paid out. This operation may not be necessary to perform if the payout in operation 105 is small enough that it does not require a reseeding. Each progressive jackpot has its own respective rules as to the payouts and when they are reseeded.

From operation 106 (or operation 104), the method proceeds to operation 107, which increases the jackpot pools based on a portion of all of the progressive wagers made in operation 100.

FIG. 1 can be applied to any casino game, such a baccarat, blackjack, Pai Gow, or any other such game.

In a first example, the inventive concept can be applied to a baccarat game (played with eight standard decks). Baccarat is a game known in the art and is described in U.S. Pat. No. 8,308,542 which is incorporated by reference herein in its entirety. The house begins by seeding three jackpots for a total of 3,200 unit: a top jackpot of 2,000 unit, a middle jackpot of 800 unit, a bottom jackpot of 400 unit.

Then, each player making the progressive does so by posting 1 unit at the start of the hand; these payouts are collected before the hand starts and, as a result, the payouts in this report are all “for 1.”

At the end of the baccarat game, the number of eights are counted, and payouts are awarded as follows a. If the first (and only) four cards out of the shoe are eights, all eligible players share the top jackpot; b. If the total hand has four eights (including drawn cards), all eligible players share the middle jackpot; c. If the total hand has three eights of the same suit (including drawn cards), all eligible players share the bottom jackpot; d. If the total hand has three eights not of the same suit (including drawn cards), all eligible players are paid 50 units each; e If the total hand has two eights, all eligible players are paid 10 units each. If one of the jackpots (a, b or c) is paid out on any given hand, it is reseeded for the next hand at its initial seed amount. If one of the flat payouts occurs (d or e) the money for these payouts comes from the float (the casino's money) but is not deducted from any jackpot pool (in other words these payouts come from the same source that winning main wagers are paid from).

After each game, each of the three jackpots is incremented by the following amount: a. Top jackpot: 0.1 units per player that played on the progressive bet; b. Middle jackpot: 0.15 units per player that played on the progressive bet; c. Bottom jackpot: 0.15 units per player who played on the progressive bet.

In another embodiment, a different progressive baccarat wager can be played on any standard eight-deck baccarat game, under the following conditions. The house begins by seeding three jackpots for a total of 3,200 units as follows: a. A top jackpot of 2,000 units; b. A middle jackpot of 800 units; c. A bottom jackpot of 400 units.

Each player who makes the progressive does so by wagering one unit at the start of the hand. The progressive wagers are collected before the hand starts and all payouts are “for 1.”

At the end of the hand, the number of nines are counted, and payouts are awarded as follows: a. If the hand uses six cards and four of them are nines, all eligible players share the top jackpot; b. If the first (and only) four cards out of the shoe are all nines, all eligible players share the middle jackpot; c. If the first (and only) four cards out of the shoe contain three nines of the same color, all eligible players share the bottom jackpot; d. If the total hand (including drawn cards) has three or more nines, all eligible players are paid 24 units each; e. If the total hand has two nines, all eligible players are paid 4 units each. 5. If one of the jackpots (a, b, c) is paid out on any given hand, it is reseeded for the next hand at its initial seed amount. If one of the flat payouts occurs (d, e), the money for these payouts comes from the float (casino money), and is not deducted from any jackpot pool

At the end of each game, the three jackpots is incremented by the following amounts : a. Top jackpot: 0.1 units per player that played; b. Middle jackpot: 0.15 units per player that played; c. Bottom jackpot: 0.15 units per player who played.

Note that “unit” as used herein means the amount of the progressive wager placed by each player. Typically the amount is a fixed amount (e.g., the progressive wager must be $1) although in another embodiment the progressive wager can be chosen at the player's choice (up to a maximum bet).

In another embodiment, a progressive baccarat wager can be played on any standard eight-deck baccarat game. The house begins by seeding three jackpots for a total of 3,200 units as follows: a. A top jackpot of 2,000 units; b. A middle jackpot of 800 units; c. A bottom jackpot of 400 units.

Each player who makes the progressive wager does so by posting 1 unit at the start of the hand, these wagers are collected before the hand starts and, as a result, the payouts in this report are all for “1”

At the end of the game, the limber of nines are counted, and payouts are awarded as follows: a. If the first (and only) four cards out of the shoe are all nines and they are all the same color, all eligible players share the top jackpot; b. If the first (and only) four cards out of the shoe are all nines but are not all of the same color, all eligible players share the middle jackpot; c. If the first (and only) four cards out of the shoe contain three nines of the same color, all eligible players share the bottom jackpot; d. If the total hand (including drawn cards) has three or more nines, all eligible players are paid 24 units each; e. If the total hand has two nines, all eligible players are paid 4 units each.

If one of the jackpots (a, b, c) is paid out on any given hand, it is reseeded for the next hand at its initial seed amount. If one of the flat payouts (d, e) occurs, the money for these payouts comes from the float, and is not deducted from any jackpot.

At the end of the game, each of the three jackpots is incremented by the following amount: a. Top jackpot: 0.1 units per player that played; b. Middle jackpot: 0.15 units per player that played; c. Bottom jackpot: 0.15 units per player who played.

In a final embodiment, on a Punto Banco or Baccarat Tables which have a Progressive Jackpot, each Player waging on a numbered betting position will have the option to make an additional and completely separate bet on the Progressive Jackpot, betting that there will be three or four “9” face value cards in the first four cards dealt, two to the Bank and two to the Player.

When the initial dealing cycle has been completed, the dealer will check the hands for progressive bets. The dealer will check for the following combinations below to ascertain which payout the guest qualifies for. a) Four red or four black 9's: The bank's (dealer's) first two cards and the player's first two cards are all 9's of the same color, i.e. all clubs and Spades or all hearts and diamonds; the top jackpot would be paid out; b) any Four 9's: The bank's first two cards and the player's first two cards are all 9's regardless of suit or color; the second Jackpot would be paid out; c) Three 9's of the same color: Of the bank's first two cards and the Player's first two cards, three cards are all 9's of the same color, i.e. all Club and Spades OR all Hearts and Diamonds; the third Jackpot would be paid out. If none of the criteria above are met (a, b, c), the progressive bet loses. Thus, the payout able is summarized as follows: a. Four Red or Four Black 9's Top Jackpot; b. Any Four 9's Second Jackpot; c. Three 9's of the Same Color Third Jackpot.

Mystery jackpots can also be offered. These are randomly generated payouts to guests playing the progressive jackpot, which may be triggered after the dealer has closed the betting on the Progressive game before any cards have been dealt; they will be paid out straight away before starting the actual hand.

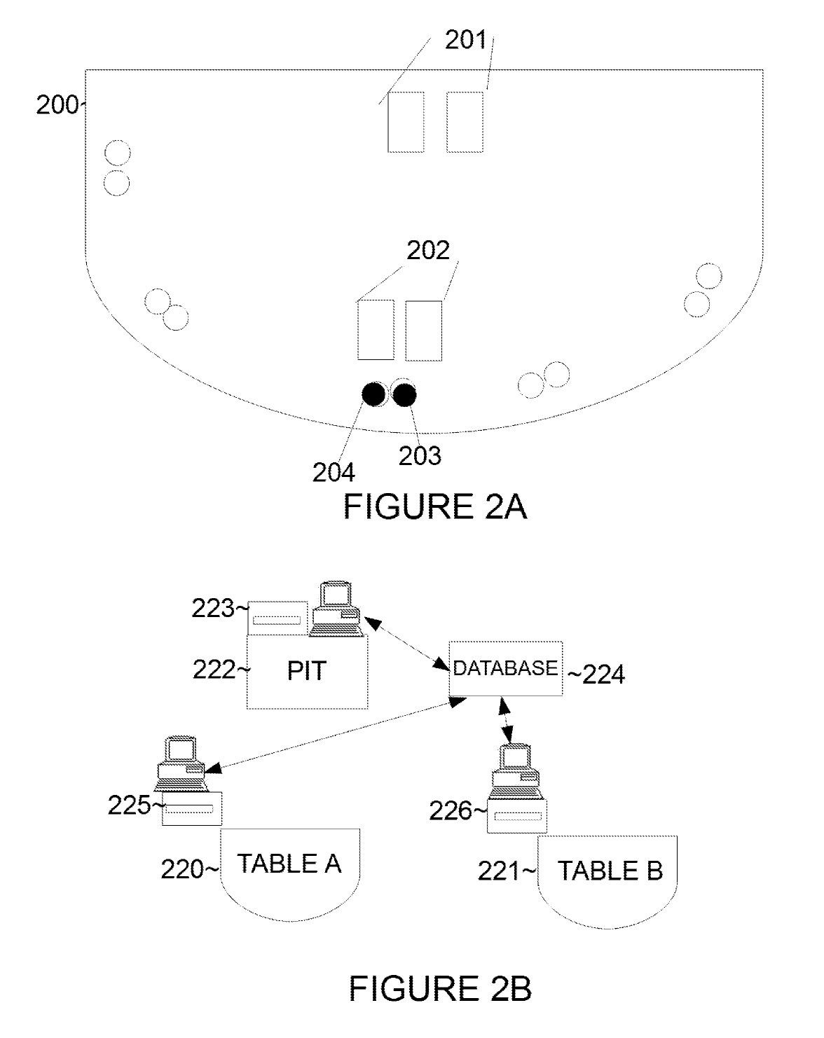

FIG. 2A is a drawing illustrating a gaming table, according to an embodiment.

A physical gaming table 200 (typically made of wood with felt on top with the layout imprinted on it) is used to play the game in a physical real world casino. One example of a table that can be used in a physical casino is illustrated in U.S. Design patent D263,975 which is incorporated by reference herein in its entirety. The layout on top of the felt has imprinted on it betting areas for each respective player. In this example, the table can accommodate six simultaneous players (each play against the same dealer hand as known in the art), although of course tables can be configured to accommodate other numbers of players as well. The felt can be green and the imprinted betting areas can be white, although of course any color scheme can be used. A player's hand 202 and a dealer's hand 201 are shown. A player's wager 203 is shown in the form of a chip or chips and is placed inside the player's betting areas. A player's progressive wager 204 is also placed inside a side wager betting circle (betting area). Note that the betting layouts can be configured in any other way, and the layout shown in FIG. 2A is merely one example.

FIG. 2B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 223, 225, 226 which can be electronic read and the data therein transmitted to the associated computer.

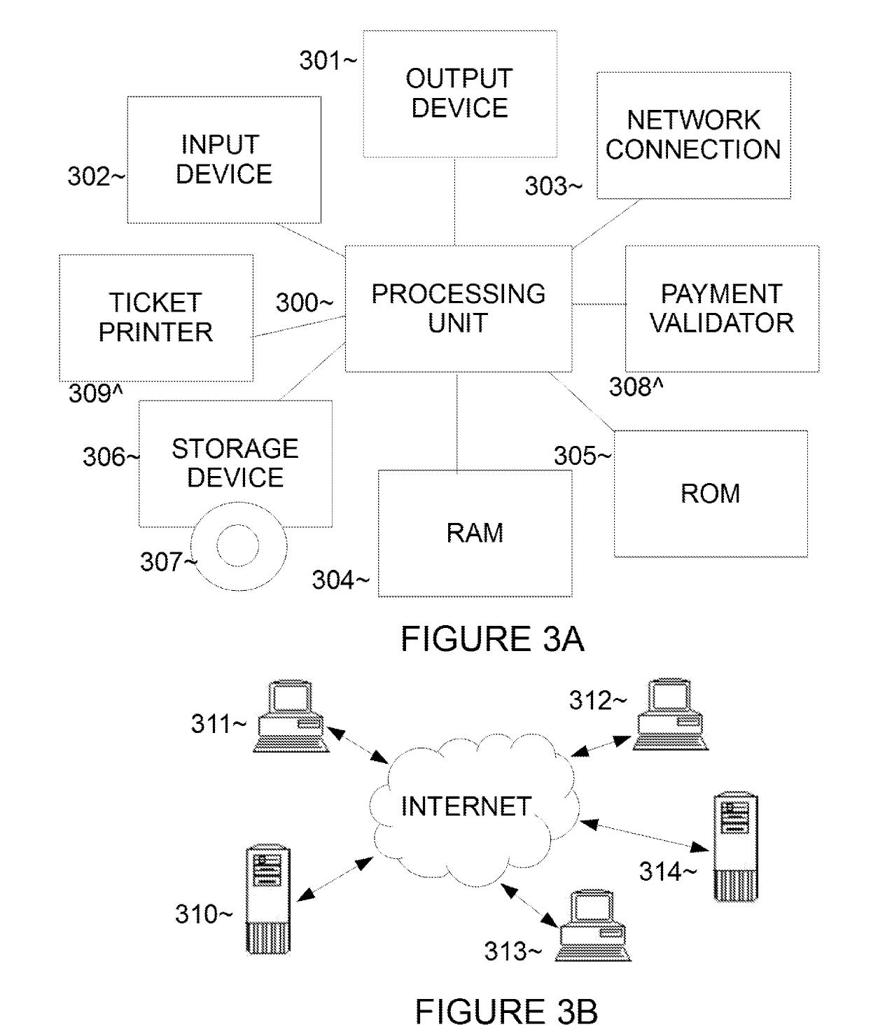

A gaming table A 220 (which can be used to play any method described herein) and a gaming table B 221 (which can be used to play any method described herein) can be associated with a pit 222 (which has its own computer) which has a card reader 223 to read the electronically encoded information on a player's card (the card reader can also be located at the tables themselves) and transmit the information to an associated computer which can communicate information contained on the player's card (e.g., an identification number of the player associated with the card) to the electronic database 224 along with play data relating to the player who owns the player's card. Table A 220 has its own card reader 225 and associated computer (the one next to card reader 325 which receives information from the card reader 225) and table B 221 also has its own card reader 226 and associated computer (the one next to card reader 226 which receives information from the card reader 226). The computers at table A 220 and table B 221 are connected to the electronic database 224. Casino employees can enter data regarding each player's play (for those players that present a players card) into a computer at the table or at the pit which transmits the play data (e.g., average bet amount, time of play, etc.) to the electronic casino database 224 that stores playing history information for players at the casino. The computers illustrated in FIG. 2B can all have the structure as illustrated in FIG. 3A.

FIG. 3A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety. The game can also be played on a video slot machine (the kind that is found in physical casinos).

A processing unit 300 (such as a microprocessor and any associated components) is connected to an output device 301 (such as an LCD monitor, touch screen, CRT, etc.) which is used to display to the player any aspect of the method, and an input device 302 (e.g., buttons, a touch screen, a keyboard, mouse, etc.) which can be used to input from the player any decision made by the player. All methods described herein can be performed by the processing unit 300 by loading and executing respective instructions. Multiple such processing units can also work in collaboration with each other (in a same or different physical location). The processing unit 300 can also be connected to a network connection 303, which can connect the electronic gaming device to a computer communications network such as the Internet, a LAN, WAN, etc. The processing unit 300 is also connected to a RAM 304 and a ROM 305. The processing unit 300 is also connected to a storage device 306 which can be a disk drive, DVD-drive, CD-ROM drive, flash memory, etc. A non-transitory computer readable storage medium 307 (e.g., hard disk, CD-ROM, etc.), can store a program which can control the electronic device to perform any of the methods described herein and can be read by the storage device 306.

The processing unit 300 can also be connected to a payment validator 308. The payment validator can be a bill acceptor which accepts currency, identifies it as being valid (typically by using an optical scanner), and then credits the inserted bill amount to the machine (for example inserting a $10 bill will credit the machine with $10 in credits). The bill acceptor can also accept cashless tickets as part of a ‘ticket-in-ticket-out” system, in which tickets (cashless vouchers) have cash value and can be inserted into the payment validator 308. The validator 308 validates the ticket (typically be optically scanning a bar-code), communicating electronically with a casino database to verify the ticket is authentic, and once authenticated then crediting the machine with the respective amount of credits. The payment validator 308 can also include a card reader which can read cards (e.g., with a magnetic stripe or other electronic encoding) so that an account number can be accessed. The cards can be a credit card, player loyalty card, specific casino payment card, or any card that can provide electronic access to a monetary amount owned by the player (owner of the card) which the player can utilize for playing the machine. If such a card is used, then the player can optionally enter (using a keypad) an amount the player wishes to withdraw from the account associated with the card to credit to the machine.

The processing unit 300 can also be connected to a ticket printer 309 which can print tickets (cashless vouchers). When the player cashes out on the machine (indicated to the machine that the player wishes to cash out and terminate by, typically by pressing a button), a ticket is printed by the ticket printer 309 which carries the amount of credits left on the machine. This ticket can then be used to play other machines in the casino by inserting them into that machine's payment validator. The ticket can also be used to redeem for cash by inserting it into a ticket redemption machine (kiosk) which receives a ticket, validates it (typically by scanning the barcode), and then dispenses an identical amount of cash to what the ticket's value is.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 3B is a network diagram showing a network structure for a social networking web site and players, according to an embodiment. The online game which awards and stores virtual points can also be accomplished by the system illustrated in FIG. 3B.

A computer communications network (such as the Internet) can be used to connect a host server 310 which can host and serve a social networking site. Note that while FIG. 3B shows only one server as the host server 310, the host server 310 can encompass numerous servers all cooperating with each other (whether in the same physical location or not). The host server 310 communicates with players 311, 312, 313 through the Internet (or other computer communication network) and can implement any of the methods herein by executing computer code programmed accordingly. Game server 314 can also implement all games and methods described herein on the site by executing computer code programmed accordingly. The game server 314 is connected to the Internet and can communicate with all of the players 311, 312, 313 directly or indirectly through the social networking site hosted by the host server 310. The game server 314 can cooperate with the host server 310 so that the games run on the game server 314 can be integrated into the social networking site hosted by the host server 310. The game server can also be optional and all of the games can be also hosted on the host server 310, whereby the integration of the games served/hosted by the game server 314 will appear embedded in the social networking site hosted by the host server 310 such that players would typically not realize (or care) that multiple servers are cooperating in order to play games on the social networking site. All of the communications described herein can be effectuated using such a network configuration. Typically, the communications are effectuated on the social networking site itself, thus the players 311, 312, 313 should be logged into the social networking site in order to participate herein, although logging in is not required (e.g., communications can be transmitted using other methods, such as email, IRC chat, instant message, etc.) The host server 310 can communicate with any of the devices illustrated in FIG. 3.

The word “deal” as used herein can mean two things: a) physically deal a card from a deck (real or virtual) face up or face down; b) reveal (turn face up a face down card) which was previously dealt. Thus, “dealing” includes taking a card from the shoe (if one is being used) and putting it on the table (face up or face down), or taking a card from the shoe (if one is being used) and putting it face down on the table and then (at a later point in time) turning it face up. Thus, if a three card hand is dealt two cards face up and one card face down (which is turned face up later), or a three card hand is dealt two cards face up and at a later time the third card is dealt face up, these are equivalent and both fall under the word “deal.” In the electronic embodiment, a dealt card means to display a virtual representation of the randomly chosen card (selected randomly from a virtual deck) of the card face up or face down.

A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, Pinochle deck(s) (consisting of two of each of the 9, 10, jack, queen, king, and ace cards for all four suits (spades, hearts, diamonds, clubs) totaling 48 cards in each deck). The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a game, the method comprising:
providing at least one standard deck(s) of cards;
providing a plurality of progressive jackpot pools;
receiving a main wager and a progressive wager;
dealing a player's hand and a dealer's hand;
resolving the game and the main wager;
determining whether the player qualifies to win one of the plurality of progressive jackpot pools out of the plurality of progressive jackpot pools; and
paying a progressive award based on the progressive wager to the player when the player qualifies to win one of the plurality of progressive jackpot pools.

2. The method as recited in claim 1, wherein the plurality of progressive jackpot pools comprises exactly three progressive jackpot pools.

3. The method as recited in claim 1, wherein the game is a baccarat game.

4. The method as recited in claim 1, wherein each of the plurality of progressive jackpot pools has its own unique paytable.

5. The method as recited in claim 1, wherein after the game is over each of the plurality of progressive jackpot pools is increased by an amount based on the progressive wager.

6. The method as recited in claim 1, wherein the progressive wager is mandatory.

7. The method as recited in claim 1, wherein the progressive wager is optional.

8. The method as recited in claim 1, wherein when the player qualifies to win one of the plurality of progressive jackpot pools, the winning progressive jackpot pool is reseeded by an predefined amount respective for the winning progressive jackpot pool.

9. The method as recited in claim 8, wherein predetermined rules provide that each of the plurality of progressive jackpot pools have different reseed amounts.

10. The method as recited in claim 4, wherein each unique paytable has a plurality of winning combinations wherein some of the winning combinations are paid out of the respective progressive jackpot pool and other of the winning combinations are not paid out of the respective progressive jackpot pool.

11. An apparatus for implementing a game, the apparatus comprising:
an electronic input device;
an electronic output device;
an electronic processor connected to the input device and output device, the processor configured to read computer readable instructions which cause the processor to:
provide at least one virtual deck(s) of cards;
provide a plurality of progressive jackpot pools;
receive a main wager and a progressive wager;
deal a player's hand and a dealer's hand;
resolve the game and the main wager;
determine whether the player qualifies to win one of the plurality of progressive jackpot pools out of the plurality of progressive jackpot pools; and
pay a progressive award based on the progressive wager to the player when the player qualifies to win one of the plurality of progressive jackpot pools.

12. The apparatus as recited in claim 11, wherein the plurality of progressive jackpot pools comprises exactly three progressive jackpot pools.

13. The apparatus as recited in claim 11, wherein the game is a baccarat game.

14. The apparatus as recited in claim 11, wherein each of the plurality of progressive jackpot pools has its own unique paytable.

15. The apparatus as recited in claim 11, wherein after the game is over each of the plurality of progressive jackpot pools is increased by an amount based on the progressive wager.

16. The apparatus as recited in claim 11, wherein the progressive wager is mandatory.

17. The apparatus as recited in claim 11, wherein the progressive wager is optional.

18. The apparatus as recited in claim 11, wherein when the player qualifies to win one of the plurality of progressive jackpot pools, the winning progressive jackpot pool is reseeded by an predefined amount respective for the winning progressive jackpot pool.

19. The apparatus as recited in claim 18, wherein predetermined rules provide that each of the plurality of progressive jackpot pools have different reseed amounts.

20. The apparatus as recited in claim 14, wherein each unique paytable has a plurality of winning combinations wherein some of the winning combinations are paid out of the respective progressive jackpot pool and other of the winning combinations are not paid out of the respective progressive jackpot pool.
